(19) United States
(12) Patent Application Publication
(10) Pub. No.: US 2026/0316448 A1
(43) Pub. Date: Oct. 15, 2026

(54) LIQUID-EJECTION HEAD SUBSTRATE, LIQUID EJECTION HEAD, AND LIQUID EJECTION APPARATUS

(71) Applicant: CANON KABUSHIKI KAISHA, Tokyo (JP)

(72) Inventors: MASASHI FUKUDA, Oita (JP); HIDENORI YAMATO, Tokyo (JP); YASUHIRO SOEDA, Kanagawa (JP)

(21) Appl. No.: 19/630,971

(22) Filed: Mar. 27, 2026

(30) Foreign Application Priority Data
Apr. 10, 2025 (JP) 2025-065045

(51) Int. Cl. B41J 2/14; B29C 64/112; B29C 64/209; B33Y 30/00; B41J 2/15; B41J 25/00

(52) U.S. Cl. CPC B41J 2/14072; B29C 64/112; B29C 64/209; B33Y 30/00; B41J 2/14112; B41J 2/15; B41J 25/005; B41J 2002/14491

(57) ABSTRACT

A technique is provided that can prevent the size of a substrate from becoming larger. To achieve this, a heater region α, sub-heater regions β, and supply port regions γ are provided in a liquid-ejection head substrate 100, the sub-heater regions β are arranged between the heater region α and the supply port regions γ, and a part of the heater region α and a part of the sub-heater region β are arranged so as to overlap in different layers.

### BACKGROUND

### Field of Technology

The present disclosure relates to a liquid-ejection head substrate including an ejection element that generate energy to eject liquid, a liquid ejection head, and a liquid ejection apparatus.

### DESCRIPTION OF THE RELATED ART

Japanese Patent Laid-Open No. 2019-10769 discloses a substrate for a liquid ejection head in which a sub-heater is arranged between an ejection element and an ink supply port in order to suppress image unevenness due to temperature distribution on the substrate. In addition, in recent years, there has been a demand for downsizing of liquid ejection heads.

In order to increase the heat generation amount by the sub-heater in the configuration of Japanese Patent Laid-Open No. 2019-10769, it is necessary to reduce the electric resistance of the sub-heater, and to increase the cross-sectional area of the sub-heater. When increasing the cross-sectional area of the sub-heater, the method for adjustment by increasing the height of the cross-sectional area is directly linked to the thickness of the sub-heater, and thus the adjustment range is limited. Therefore, it is conceivable to perform adjustment by widening the cross-sectional area in the width direction.

However, by widening the sub-heater in the width direction, the distance between the ejection element and the ink supply port is increased, and there is a concern that the substrate becomes larger. There is a problem that as the size of the substrate is increased, the size of the liquid ejection head itself is also increased.

### SUMMARY

Therefore, the present disclosure provides a technique that can prevent, in a substrate provided with a sub-heater for making the temperature distribution of the substrate uniform, the size of the substrate from becoming larger.

Therefore, a liquid-ejection head substrate of the present disclosure includes an ejection port that ejects liquid supplied from a supply port by an action of an ejection element, and a heating element that preliminarily heats the liquid before the liquid is ejected from the ejection port, in which the liquid-ejection head substrate includes a first region including the ejection element and a connecting portion that electrically connects the ejection element and wiring, boundaries of the first region being defined by a position of the connecting portion, a second region that is a region of the heating element, and a third region that is a region of the supply port, and when seen from an ejection direction of the liquid, the second region is arranged between the first region and the third region, and at least a part of the first region and at least a part of the second region are arranged to overlap in different layers.

According to the present disclosure, a technique can be provided that can prevent, in a substrate provided with a sub-heater for making the temperature distribution of the substrate uniform, the size of the substrate from becoming larger.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing a liquid-ejection head substrate;

FIG. 2 is a diagram showing the liquid-ejection head substrate;

FIG. 3 is a diagram showing the liquid-ejection head substrate;

FIG. 4 is a diagram showing the liquid-ejection head substrate;

FIG. 5 is a diagram showing a liquid-ejection head substrate;

FIG. 6 is a diagram showing the liquid-ejection head substrate;

FIG. 7 is a diagram showing the liquid-ejection head substrate;

FIG. 8 is a diagram showing the liquid-ejection head substrate;

FIG. 9 is a diagram showing an example of a circuit configuration of a liquid-ejection head substrate;

FIG. 10 is a diagram showing a part of an example of the configuration of a liquid-ejection head substrate and an ink supply unit;

FIG. 11 is a diagram showing the appearance of a liquid ejection head; and

FIG. 12 is a diagram showing the appearance of a liquid ejection apparatus.

### DESCRIPTION OF THE EMBODIMENTS

### First Embodiment

Hereinafter, a first embodiment of the present disclosure will be described with reference to the drawings.

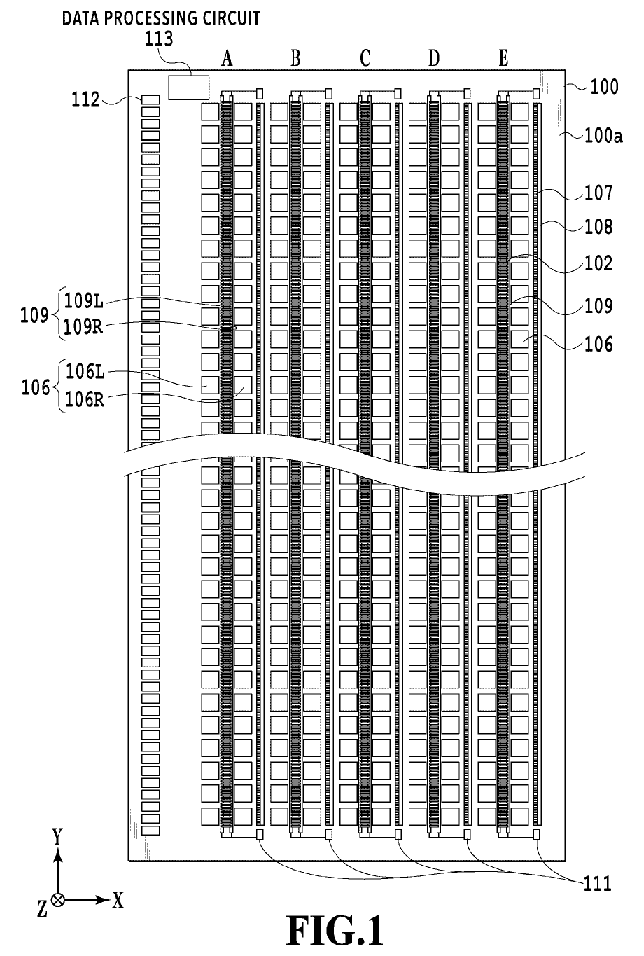

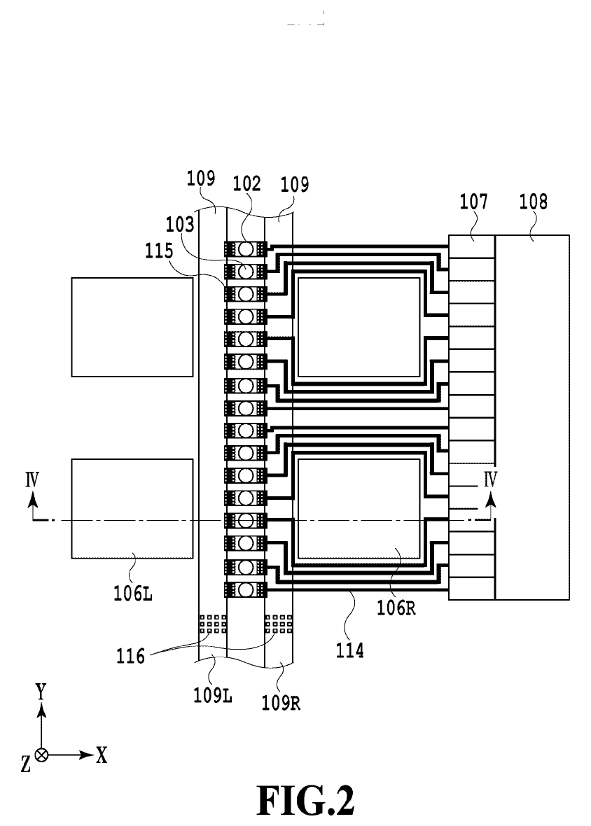

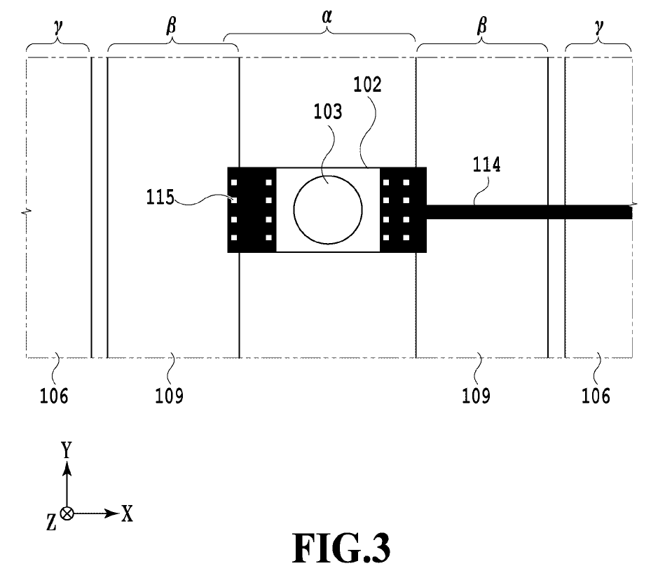

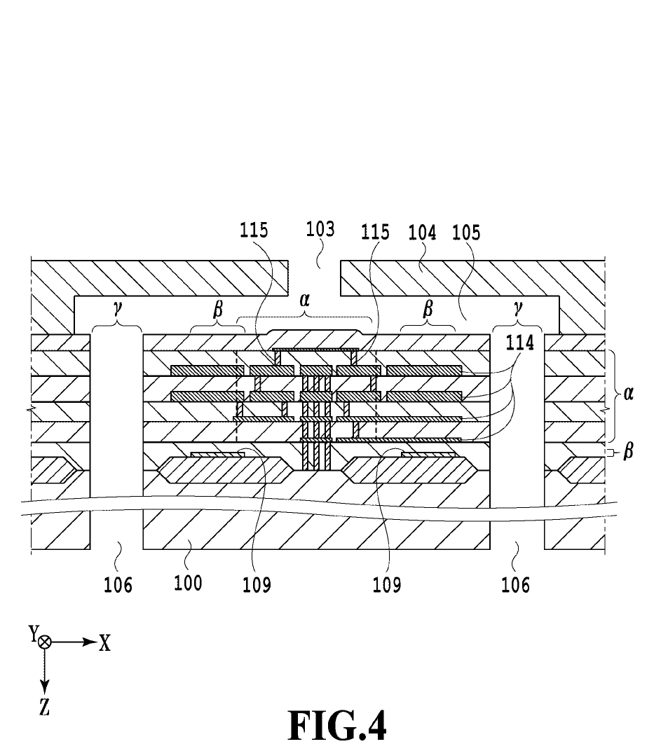

FIG. 1 is a plan view of an entire liquid-ejection head substrate 100 to which the present embodiment can be applied, FIGS. 2 and 3 are enlarged plan views of a portion near an ejection element 102 in FIGS. 1, and 4, is an enlarged cross-sectional view taken along line IV-IV in FIG. 2.

On the liquid-ejection head substrate 100, ejection elements 102 for generating energy to eject liquid (hereinafter also referred to as ink) are arranged at regular intervals along a predetermined direction (a Y direction), and these ejection elements 102 form an ejection element array. In the liquid-ejection head substrate 100 shown in FIG. 1, five ejection element arrays (an array A, an array B, an array C, an array D, and an array E) are arranged at different positions in a short side direction (an X direction, a predetermined direction) perpendicular to a long side direction (the Y direction) thereof. The ejection elements 102 in the present embodiment are constituted by heat generating elements that generate heat by being electrified.

An ejection port forming member 104 having ejection ports 103 formed therein for ejecting ink is bonded to one surface 100a of the liquid-ejection head substrate 100. A flow path 105 is formed between the ejection port forming member 104 and the liquid-ejection head substrate 100. In addition, in the ejection port forming member 104, the ejection ports 103 are formed at the positions facing the ejection elements 102. Accordingly, a nozzle array is formed at the position corresponding to an ejection element array.

A plurality of supply ports 106 that supply ink to the ejection elements 102 are arranged along the Y direction on both sides of each ejection element array (on both sides in the X direction in FIG. 1) to form a supply port array. Here, for every eight ejection elements 102, one supply port 106 is arranged on each of the left and right sides. In addition, a plurality of drive circuits 107 that drive the plurality of ejection elements 102, respectively, and a plurality of selection circuits 108 that select the plurality of ejection elements 102, respectively, are arranged along each ejection element array so as to correspond to each ejection element array. When current is passed through the ejection element 102 at arbitrary timing, bubbles are generated in the ink due to the heat generated by the action of the ejection element 102, and the pressure at the time of generation of the bubbles causes the ink in the flow path 105 to be ejected as ink droplets from the ejection port 103.

In addition, a plurality of sub-heaters (heating elements) 109 are provided between the supply ports 106 and the ejection elements 102 to preliminarily heat the ink supplied from the supply ports 106 to the ejection elements 102 before the ink is ejected from the ejection ports. That is, when the liquid-ejection head substrate 100 is seen in plan view from a Z direction, the sub-heaters 109 are located between the ejection element array and the supply port arrays, and extend in the direction of the ejection element array to form an array (a heating element array). The ejection element array has a higher array density than the supply port array, and the supply port array has a higher array density than the heating element array. The sub-heater 109 has a function of heating the liquid-ejection head substrate 100 and the ink inside the liquid-ejection head substrate 100 to a degree that does not cause the ink to bubble, and keeping the temperature. The sub-heater 109 is constituted by a heat generating element that generates heat when current is passed through it, and is connected to a sub-heater driver 111. It should be noted that the sub-heater 109 can be constituted by a diffusion resistance material of a Poly-Si or Si substrate.

The sub-heater driver 111 is provided for each of a plurality of preheating areas defined within the liquid-ejection head substrate 100. By laying out the sub-heaters 109 and sub-heater drivers 111 so that the heat generation amount by the sub-heaters 109 in each area is equal, it becomes possible to uniformly control the temperature distribution in the liquid-ejection head substrate 100. In addition, a sub-heater 109L is arranged between the ejection elements 102 and supply ports 106L located in a -X direction of the ejection elements 102, and a sub-heater 109R is arranged between the ejection elements 102 and supply ports 106R located in the X direction of the ejection elements 102. With this arrangement, the ink is heated near the ejection elements 102, and therefore the ink can be more efficiently preheated. It should be noted that in the following description, when there is no need to particularly distinguish between the sub-heaters 109L and 109R located on both sides of the ejection elements 102 in the X direction, they will be collectively referred to as the sub-heater 109.

In addition, a plurality of pads 112 are provided on an end portion of the liquid-ejection head substrate 100. These pads 112 include signal terminals for inputting signals to the ejection elements 102 and the sub-heater drivers 111, power supply terminals for connecting to a power supply, and the like. An arbitrary sub-heater driver 111 is controlled to be conductive by sub-heater control signals that are input from the plurality of pads 112 and the power supply. By passing current through the sub-heater 109 to generate heat, an arbitrary one of the plurality of pre-heating areas provided in the liquid-ejection head substrate 100 can be independently heated. The sub-heater control signals may be configured to be directly supplied to the sub-heater driver 111 from the plurality of pads 112, or a data processing circuit 113 may be provided as a control unit in the liquid-ejection head substrate 100 to output the sub-heater control signal.

As shown in FIG. 2, heater contact portions (connecting portions) 115 are arranged on both sides in the X direction of the plurality of ejection elements 102 in each array. The heater contact portions 115 in the X direction with respect to the ejection elements 102 are connected to the plurality of drive circuits 107 via wiring portions 114. In addition, the heater contact portions 115 in the -X direction with respect to the ejection elements 102 are connected to the plurality of pads 112 (refer to FIG. 1) via wiring (not shown) that passes current to the plurality of ejection elements 102. The plurality of ejection elements 102 can be driven by passing current through the plurality of pads 112. It should be noted that FIGS. 2 and 3 show only the heater contact portions 115 that are closest and farthest from the center of the ejection element 102 among the heater contact portions 115 that contribute to current injection of the ejection elements 102. The positions and number of the heater contact portions 115 to be arranged vary depending on the amount of current flowing through the ejection elements 102, and the like. In addition, the plurality of ejection elements 102 and the wiring portions 114 may be made of at least one of Cu, Al, Au, Ni, W, Ti, and compounds thereof. In addition, the plurality of sub-heaters 109 in respective arrays are connected by sub-heater contact portions 116 via wiring portions (not shown) from the plurality of sub-heater drivers 111.

In the present embodiment, as shown in FIG. 3, a region in which the plurality of ejection elements 102 and the plurality of heater contact portions 115 are arranged is defined as a heater region (a first region) α. In addition, a region in which the plurality of sub-heaters 109 are arranged is defined as a sub-heater region (a second region) β. Furthermore, a region in which the plurality of supply ports 106 are arranged is defined as a supply port region (a third region) γ. Specifically, as shown in FIG. 4, the positions of the heater contact portions 115 that are arranged farthest from the ejection element 102 in the X direction are set as the boundaries of the heater region. In addition, when seen from an ejection direction (a -Z direction) as in FIG. 3, the sub-heater region β is arranged between the heater region α and the supply port region γ, and a part of the heater region α and a part of the sub-heater region β are arranged so as to overlap in different layers. Accordingly, the distance from the ejection element 102 to the supply port 106 can be shortened, and downsizing of the liquid-ejection head substrate 100 can be achieved.

It should be noted that in the present embodiment, an example is shown in which the sub-heater region β in the -X direction partially overlaps with the heater region α, but this s not a limitation. A configuration may be adopted in which a part of the sub-heater region β in the ±X direction overlaps with the heater region α. In this configuration, further downsizing of the liquid-ejection head substrate 100 can be achieved.

As shown in FIG. 4, the boundary of the heater region α in the X direction is defined as the outer end of the heater contact portion 115 corresponding to the ejection element 102 located at a position farthest from the center of the ejection element 102. In addition, the boundaries of the heater region α in the Y direction are defined as an upper end of a heater layer in which the ejection elements 102 are located and a lower end of a lowermost layer of the wiring portion 114 that contributes to driving of the ejection elements 102.

On the other hand, for the sub-heater region β, the boundaries in the X direction are defined by the horizontal width of a layer used as the sub-heater 109, and the boundaries in the Z direction are defined by the thickness of the sub-heater 109.

In the present embodiment, as shown in FIG. 4, the sub-heater regions β are arranged in the ±X directions relative to the heater region α, and when seen from the Z direction, a portion of the heater region α and a portion of the sub-heater region β are arranged so as to overlap in different layers. In addition, the heater region α is formed closer to a front surface of the liquid-ejection head substrate 100 than the sub-heater regions β.

In addition, in the present embodiment, as shown in FIG. 2, the sub-heater contact portion 116 is arranged in a straight line with the sub-heater 109. By making the sub-heater width near the sub-heater contact portion 116 wider than the other portions (it is shown with the same width as the other portions in FIG. 2), the number of contacts can be increased, which is a more preferable design in terms of reliability.

On the other hand, in terms of shortening the distance from the ejection element 102 to the supply port 106, increasing the sub-heater width is not preferable. Thus, although different from the configuration in the present embodiment, the sub-heater contact portion 116 may be arranged at a position distant from the sub-heater region β, so as to make it easier to shorten the distance from the ejection element 102 to the supply port 106.

As described above, in the present embodiment, the liquid-ejection head substrate 100 is provided with the heater region α, the sub-heater regions β, and the supply port regions γ. In addition, the sub-heater region β is arranged between the heater region α and the supply port region γ, and a part of the heater region α and a part of the sub-heater region β are arranged so as to overlap in different layers. Accordingly, a technique can be provided that can prevent, in a substrate provided with sub-heaters for making the temperature distribution of the substrate uniform, the size of the substrate from becoming larger.

### Second Embodiment

Hereinafter, a second embodiment of the present disclosure will be described with reference to the drawings. It should be noted that the basic configuration in the present embodiment is similar to that in the first embodiment, and therefore, the characteristic configuration will be described below.

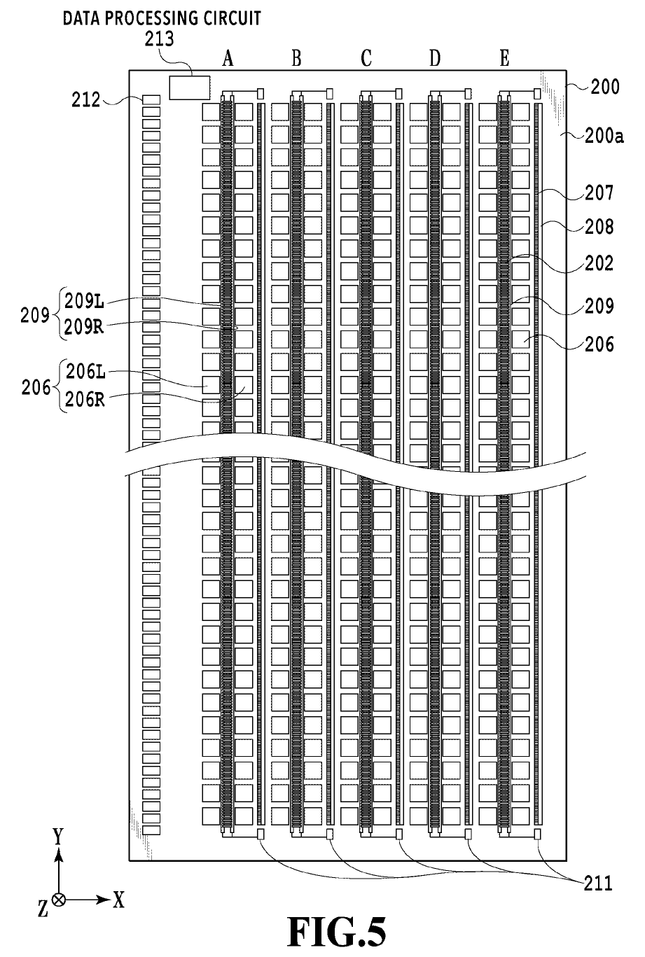

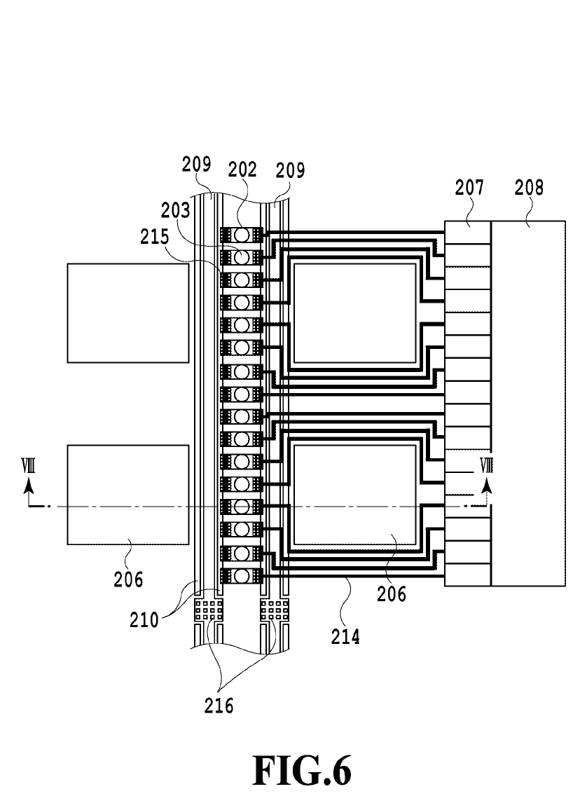

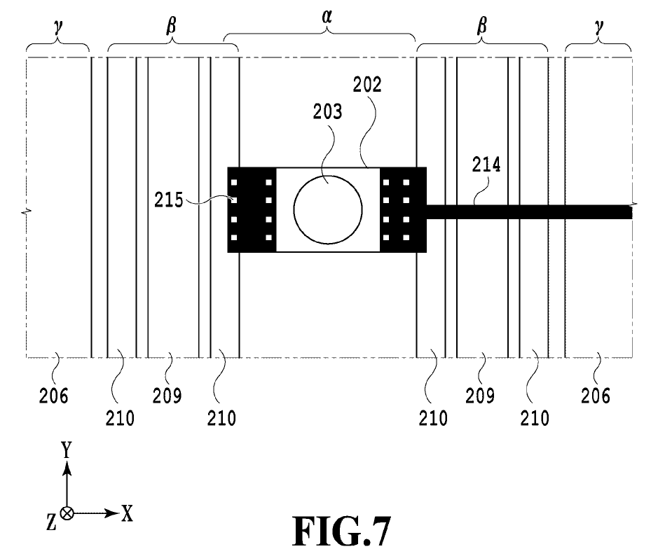

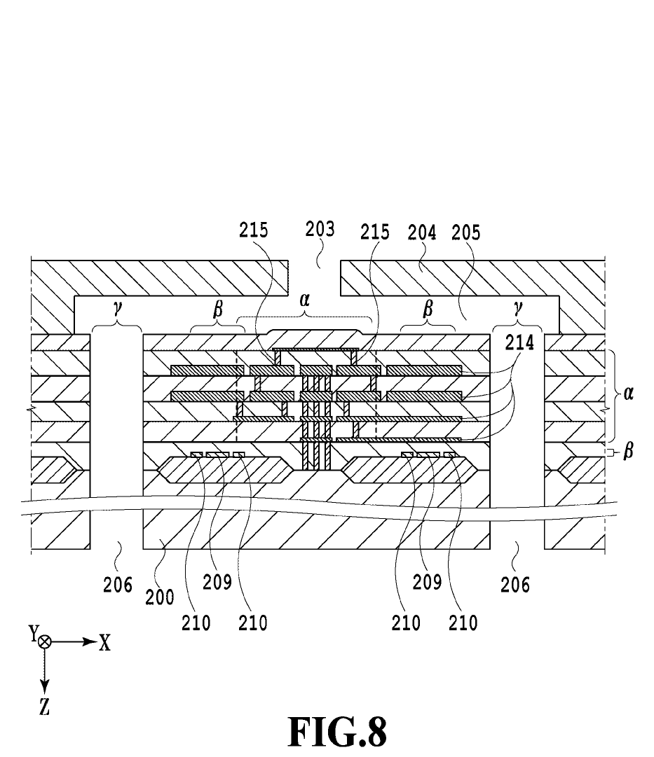

FIG. 5 is a plan view of an entire liquid-ejection head substrate 200 to which the present embodiment can be applied, FIGS. 6 and 7 are enlarged plan views of a portion near an ejection element 202 in FIG. 5, and FIG. 8 is an enlarged cross-sectional view taken along line VIII-VIII in FIG. 6.

The liquid-ejection head substrate 200 in the present embodiment includes sub-heaters 209 and sub-heater dummy patterns 210. The sub-heater 209 in the present embodiment has a narrower width in the X direction than the sub-heater 109 in the first embodiment. The width of the sub-heater in the X direction varies depending on the ink to be used, and the like. The present embodiment can be applied to cases where ink that does not require a high heat generation amount is used, and the like.

In cases where the sub-heater does not need a high heat generation amount, the width in the X direction can be narrowed. However, it is difficult to stably produce a narrower pattern. Therefore, in the present embodiment, the sub-heaters 209 and the sub-heater dummy patterns 210 are simultaneously formed, and the narrow sub-heater 209 and the sub-heater dummy patterns 210 arranged on both sides of the sub-heater 209 so as to extend along the sub-heater 209 are provided. Accordingly, a stable pattern can be formed, and the width of the sub-heater 209 in the X direction can be narrowed. It should be noted that the sub-heater dummy patterns 210 are not electrified.

As shown in FIG. 6, the plurality of sub-heaters 209 in respective arrays are connected by sub-heater contact portions 216 via wiring portions (not shown) from the plurality of sub-heater drivers 211. The portion of the sub-heater 209 in which the sub-heater contact portions 216 are provided is wider in the X direction than the other portions, and the sub-heater dummy patterns 210 extend in the Y direction, sandwiching the portion in which the sub-heater contact portions 216 are provided. By making the sub-heater width near the sub-heater contact portions 216 wider than the other portions, the number of contacts can be increased, which is desirable from in terms of reliability.

In the present embodiment, as shown in FIG. 7, the region in which the plurality of ejection elements 202 and the plurality of heater contact portions 215 are arranged is defined as the heater region (the first region) α. The manner for setting the boundaries of the heater regions is similar to that in the first embodiment. In addition, the region in which the plurality of sub-heaters 209 are arranged is defined as the sub-heater region (the second region) β. Furthermore, the region in which the plurality of supply ports 206 are arranged is defined as the supply port region (the third region) γ. In addition, the sub-heater region β is arranged between the heater region α and the supply port region γ, and when seen from the Z direction as in FIG. 7, a part of the heater region α and a part of the sub-heater region β are arranged so as to overlap in different layers. Accordingly, the distance from the ejection element 202 to the supply port 206 can be shortened, and downsizing of the liquid-ejection head substrate 200 can be achieved.

It should be noted that in the present embodiment, as an example, the configuration has been described in which the sub-heater dummy patterns 210 are provided on both sides of the sub-heater 209 in the X direction, but this is not a limitation. Depending on the width of the sub-heater 209, the sub-heater dummy pattern 210 may be provided only on one side of the sub-heater 209 in the X direction (along the sub-heater 209).

As described above, in the present embodiment, the liquid-ejection head substrate 200 is provided with the heater region α, the sub-heater regions β in which the plurality of sub-heaters 209 and the plurality of sub-heater dummy patterns 210 are arranged, and the supply port regions γ. In addition, the sub-heater region β is arranged between the heater region α and the supply port region γ, and a part of the heater region α and a part of the sub-heater region β are arranged so as to overlap in different layers. Accordingly, a technique can be provided that can prevent, in a substrate provided with sub-heaters for making the temperature distribution of the substrate uniform, the size of the substrate from becoming larger.

### Third Embodiment

Hereinafter, a third embodiment of the present disclosure will be described with reference to the drawings. It should be noted that the basic configuration in the present embodiment is similar to that in the first embodiment, and therefore, the characteristic configuration will be described below. In the present embodiment, as an application example of the liquid-ejection head substrate 100 described in the first embodiment or the liquid-ejection head substrate 200 described in the second embodiment, a description will be given of an example in which the liquid-ejection head substrate 100 or 200 is applied to a printing apparatus. It should be noted that although a description will be given below by taking the liquid-ejection head substrate 100 as an example, the description is also applicable to the liquid-ejection head substrate 200.

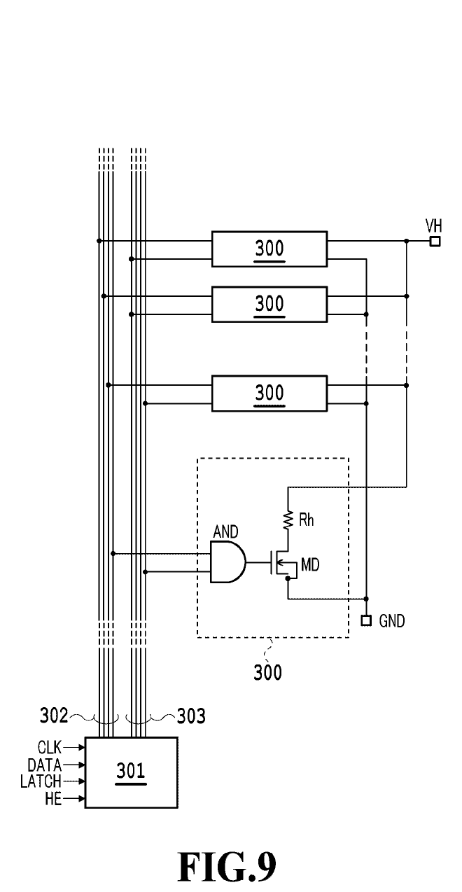

FIG. 9 is a diagram showing an example of the circuit configuration of the liquid-ejection head substrate 100. A printing unit 300 includes a heater resistor Rh and a driving unit (for example, a transistor MD and a logical product circuit AND) that drives the heater resistor Rh. By driving the heater resistor Rh, that is, by electrifying the heater resistor Rh to generate heat, a printing material is ejected, and printing can be performed.

A control circuit 301 can be constituted by, for example, a shift register, a latch circuit, and the like (not shown). A clock signal CLK, an image data signal DATA, a latch signal LT, and a heater control signal HE may be input to the control circuit 301 via, for example, a host PC or the like that is not shown. In addition, as a power supply voltage for logic, a power supply voltage VDD (for example, 3 to 5 V) is supplied to logical product circuits AND and NAND and the control circuit 301. Thus, the heater resistors Rh of the printing units 300 are each electrically connected to the control circuit 301.

Here, the control circuit 301 can perform time-division driving that drives the heater resistors Rh by controlling, for example, the operations of the printing units 300 for each of m groups, each group having n printing units 300. The time division driving is performed by the control circuit 301 outputting an m-bit group selection signal 302 for selecting m groups and an n-bit block selection signal 303 for selecting n printing units 300 in a group.

The corresponding group selection signal 302 and block selection signal 303 are input to the logical product circuit AND, and when both signals are in an on state, the logical product circuit AND turns on the transistor MD. When the transistor MD is in an on state, the transistor MD drives the heater resistor Rh connected in series. Here, it is assumed that the printing unit 300 is supplied with a power supply voltage VH (for example, 28 V) as a power supply voltage for driving the heater, and the ground potential is GND.

A control signal and the block selection signal 303 are input to the logical product circuit NAND, and a signal corresponding to these is output from an inverter to the transistor MD, and the on state/off state of the transistor MD is switched. It should be noted that although FIG. 9 shows the configuration in which all the recording units 300 are connected to the control circuit 301, a configuration may be adopted in which each of the recording units 300 is connected to a different control circuit.

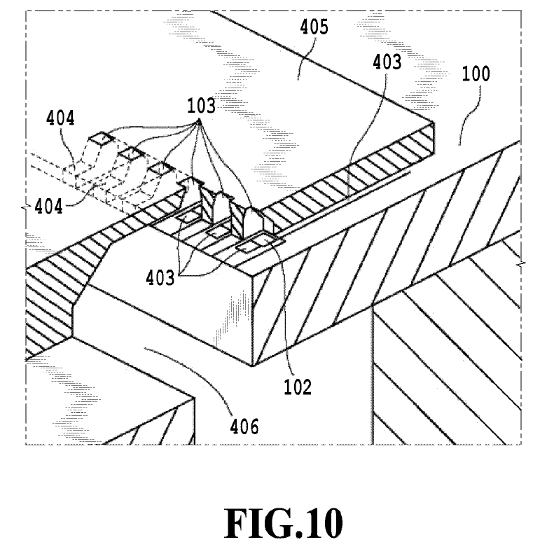

FIG. 10 is a diagram schematically showing a part of an example of the configuration of the liquid-ejection head substrate 100 and the ink supply unit. The liquid-ejection head substrate 100 includes the plurality of ejection elements 102 arranged corresponding to the ejection ports 103 for ejecting the ink. By driving the ejection elements 102, the ink is heated and bubbled, and the ink is ejected from the ejection ports 103. Electrodes 403 are electrodes for electrifying the ejection elements 102, and is electrically connected to, for example, driving elements that drive the ejection elements 102. Each ejection port 103 is coupled to a common liquid chamber 406 via a corresponding ink flow path 404 so that the ink for ejection is supplied. A member 405 has grooves therein so as to form the ejection ports 103, the flow paths 404, and the common liquid chamber 406.

It should be noted that, here, the liquid-ejection head substrate that ejects the ink by performing heating using the ejection elements 102 has been illustrated as an example, but the liquid-ejection head substrate is not limited to this. For example, a configuration may be adopted in which a piezo element is used as an ejection element instead of the ejection element 102.

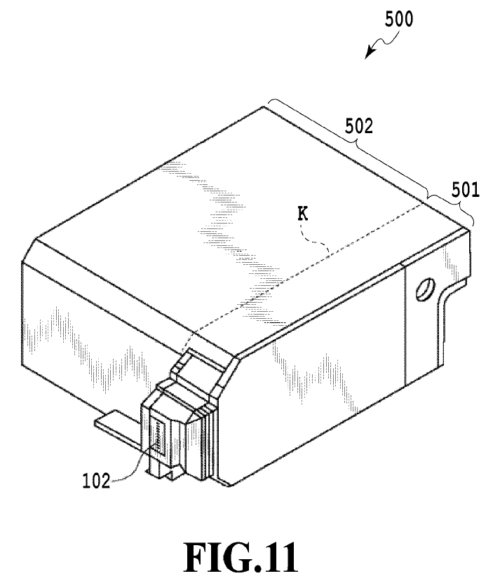

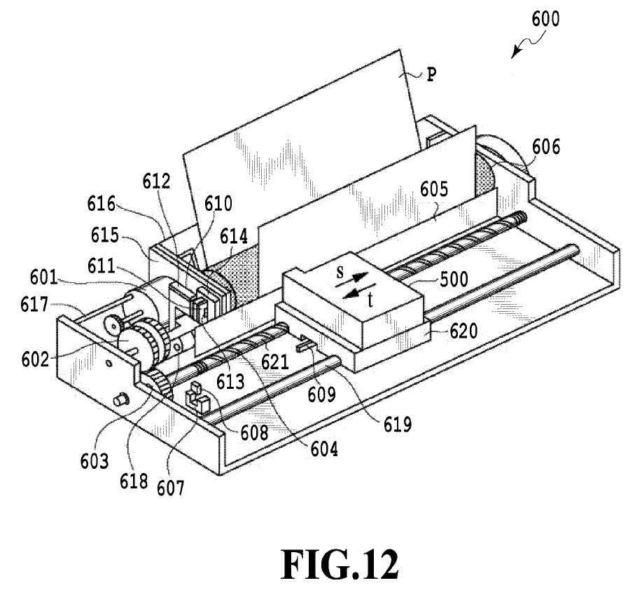

FIG. 11 is a diagram showing the appearance of a liquid ejection head 500. The liquid ejection head 500 includes a liquid ejection head portion 501 having a plurality of ejection ports 103 and a liquid-ejection head substrate 100 provided to face the plurality of ejection ports 103 (refer to FIG. 10), and an ink tank 502 attached to the liquid ejection head portion 501. The ink tank 502 holds ink to be supplied to the liquid ejection head portion 501. The ink tank 502 and the liquid ejection head portion 501 can be separated at, for example, a dashed line K, and the ink tank 502 can be replaced. The liquid ejection head 500 includes an electric contact (not shown) for receiving an electric signal from a carriage 620 (refer to FIG. 12 that will be described later), and ejects the ink in accordance with the electric signal to perform the above-described printing. The ink tank 502 has, for example, a fibrous or porous ink holding material (not shown), and holds the ink by the ink holding material.

FIG. 12 is a diagram showing the appearance of a liquid ejection apparatus 600. The liquid ejection head 500 is configured so as to be mountable on the carriage 620 together with the ink tank 502 (refer to FIG. 11). The liquid ejection apparatus 600 is a serial type image forming apparatus that forms an image by alternately repeating a conveying operation of a printing paper P and a printing operation of scanning the liquid ejection head 500. The carriage 620 is attached to a lead screw 604 having a spiral groove 621. By the rotation of the lead screw 604, the liquid ejection head 500 moves together with the carriage 620 along the guide 619 in the direction of an arrow s or t. The rotation of the lead screw 604 is linked to the rotation of a driving motor 601 via drive force transmission gears 602 and 603.

The printing paper P is conveyed onto a platen 606 by a conveying unit (not shown). A paper pressing plate 605 presses the printing paper P against the platen 606 along a carriage movement direction. The liquid ejection apparatus 600 checks the position of a lever 609 provided to the carriage 620 via photocouplers 607 and 608, and performs switching of the rotation direction of the driving motor 601, and the like. A support member 610 supports a cap member 611 that caps each ejection port 103 of the liquid ejection head 500. A suction unit 612 sucks the inside of the cap member 611, and performs a suction recovery process of the liquid ejection head 500 through an in-the-cap opening 613.

A well-known cleaning blade is used as a cleaning blade 614, and a moving member 615 moves the cleaning blade 614 in a front-rear direction. A main body support plate 616 supports the moving member 615 and the cleaning blade 614. A lever 617 is provided to initiate the suction recovery process.

The lever 617 moves in conjunction with the movement of a cam 618 that is engaged with the carriage 620. The driving force from the drive motor 601 is controlled by known transmission means such as a clutch switch. The liquid ejection apparatus 600 is provided with a print control unit (not shown), and the liquid ejection apparatus 600 can control the driving of each mechanism in accordance with an electric signal such as print data from the outside. The liquid ejection apparatus 600 repeats the reciprocal movement of the liquid ejection head 500 and the conveyance of the printing paper P by the conveying unit (not shown) to complete printing on the printing paper P.

In addition, the above-described liquid ejection apparatus can also be used as an apparatus for forming a three-dimensional image based on 3D data.

In this manner, by applying the liquid-ejection head substrate 100 in the first embodiment or the liquid-ejection head substrate 200 in the second embodiment to a liquid ejection apparatus, the distance from the ejection element to the supply port can be shortened, and the size of the substrate used in the liquid ejection apparatus can be prevented from becoming larger.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-065045, filed April 10, 2025, which is hereby incorporated by reference herein in its entirety.

What is claimed is:

1. A liquid-ejection head substrate comprising:
an ejection port that ejects liquid supplied from a supply port by an action of an ejection element; and
a heating element that preliminarily heats the liquid before the liquid is ejected from the ejection port, wherein the liquid-ejection head substrate includes:
a first region including the ejection element and a connecting portion that electrically connects the ejection element and wiring, boundaries of the first region being defined by a position of the connecting portion;
a second region that is a region of the heating element; and
a third region that is a region of the supply port, and
when seen from an ejection direction of the liquid,
the second region is arranged between the first region and the third region, and
at least a part of the first region and at least a part of the second region are arranged to overlap in different layers.

2. The liquid-ejection head substrate according to claim 1, further comprising:
a nozzle array in which a plurality of the ejection ports are arranged,
wherein a plurality of the nozzle arrays are arranged in a predetermined direction,
the ejection element is electrically connected to a plurality of the connecting portions, and
boundaries of the first region are defined by positions of the connecting portions provided at farthest positions from the ejection element in the predetermined direction.

3. The liquid-ejection head substrate according to claim 1, wherein the first region is provided by being sandwiched between the second regions.

4. The liquid-ejection head substrate according to claim 3, wherein the first region and the second regions sandwiching the first region are provided by being sandwiched between the third regions.

5. The liquid-ejection head substrate according to claim 1, wherein the first region is provided closer to a surface than the second region.

6. The liquid-ejection head substrate according to claim 1, wherein in the second region, a dummy pattern formed simultaneously with the heating element is provided along the heating element.

7. The liquid-ejection head substrate according to claim 6, wherein in the second region, the heating element is provided by being sandwiched between the dummy patterns.

8. The liquid-ejection head substrate according to claim 2, wherein the ejection element is provided as an ejection element array in which a plurality of the ejection elements are arranged,
the heating element is provided as a heating element array in which a plurality of the heating elements are arranged,
the supply port is provided as a supply port array in which a plurality of the supply ports are arranged, and
the ejection element array has a higher array density than the supply port array, and the supply port array has a higher array density than the heating element array.

9. The liquid-ejection head substrate according to claim 1, wherein the ejection element is made of at least one of Cu, Al, Au, Ni, W, Ti, and compounds thereof.

10. The liquid-ejection head substrate according to claim 1, wherein the heating element is made of a diffusion resistance material of a Poly-Si or Si substrate.

11. A liquid ejection head comprising the liquid-ejection head substrate according to claim 1.

12. A liquid ejection apparatus capable of mounting a liquid ejection head comprising the liquid-ejection head substrate according to claim 1.

13. The liquid ejection apparatus according to claim 12, wherein the liquid ejection apparatus is a serial type image forming apparatus that forms an image by alternately repeating a conveying operation of conveying a printing paper and a printing operation of scanning the liquid ejection head.

14. The liquid ejection apparatus according to claim 12, wherein a three-dimensional image is formed from 3D data.
